(19) United States
(12) Patent Application Publication
(10) Pub. No.: US 2026/0072336 A1
(43) Pub. Date: Mar. 12, 2026

(54) LIGHT SOURCE, LIGHT SOURCE SYSTEM AND PROJECTOR

(71) Applicant: TriLite Technologies GmbH, Wien (AT)

(72) Inventors: Gerhard SCHMID, Waldkirchen (AT); Franz Josef MAIER, Poertschach am Woerthersee (AT); Manuel DORFMEISTER, Wien (AT); Joerg REITTERER, Brunn am Gebirge (AT)

(21) Appl. No.: 19/323,452

(22) Filed: Sep. 9, 2025

(30) Foreign Application Priority Data
Sep. 10, 2024 (EP) 24199403.7

(51) Int. Cl. G03B 21/20

(52) U.S. Cl. CPC G03B 21/2033

(57) ABSTRACT

The disclosed subject matter relates to a light source for a projector projecting pixels, which receives, for each pixel, a respective brightness value indicating a target brightness, forms, for each brightness value, a respective current pulse, thus forming current pulses, superimposes a constant bias current and the current pulses for obtaining a driving current for driving a laser diode, wherein the laser diode transforms each current pulse into a respective laser pulse having the target brightness of the respective pixel, wherein said bias current is less than 90% of a threshold current for lasing and the light source calculates amplitudes of the current pulses from the brightness values and forms the current pulses such that each two consecutive current pulses are separated by a pause. The disclosed subject matter further relates to a light source system and a projector.

### CROSS-REFERENCE TO RELATED APPLICATIONS

This application claims priority to European Patent Application No. 24 199 403.7 filed Sep. 10, 2024, the disclosure of which is incorporated herein by reference.

### TECHNICAL FIELD

The present disclosed subject matter relates to a light source for a projector projecting an image comprised of pixels, the light source comprising a laser diode and a laser diode driver, wherein the laser diode driver is configured to receive, for each pixel of the image, a respective brightness value indicating a target brightness of that pixel, to form, for each brightness value, a respective current pulse having an amplitude corresponding to that brightness value, to superimpose a constant bias current and the current pulses for obtaining a driving current, and to drive the laser diode with the driving current, and wherein the laser diode is configured to lase when the driving current exceeds a threshold current and to transform each current pulse into a respective laser pulse yielding the target brightness of the respective pixel. The disclosed subject matter further relates to a light source system and a projector comprising said light source or light source system.

### BACKGROUND

Light sources of the abovementioned kind are commonly used in projectors of virtual reality (VR) or augmented reality (AR) glasses or helmets, video beamers, head-up-displays (HUDs), etc. in a broad range of applications like navigation, training, entertainment, education, work, etc., i.a. due to the high energy efficiency and directivity of laser diodes. In such applications, the light source(s) is/are usually combined with one or more oscillating mirrors to form a projector, wherein the mirror(s) deflect and scan the laser pulses over an image area to project one pixel after the other. The bias current is set to equal the threshold current for lasing and the amplitudes of the current pulses superimposed with the bias current account for the portion of the driving current above the threshold current. Consequently, the control of the pixel brightness is simple; in the simplest, namely linear case, the amplitude value equals the brightness value. Being permanently biased to the edge of its lasing regime, the laser diode generally emits coherent laser pulses and the response of the laser diode to each current pulse is fast. In some applications, however, the coherence of the emitted laser pulses causes undesired interference effects such as speckles, e.g. when the laser pulses are projected onto a rough surface, so-called Newton rings, e.g. when the laser pulses are guided through a waveguide (e.g. of a waveguide combiner), fringes, or the like, in any case deteriorating the quality of the projected image.

### BRIEF SUMMARY

It is an object of the present disclosed subject matter to provide a light source and a projector, which both allow for projecting an image at a high quality.

In a first aspect of the disclosed subject matter, this object is achieved with a light source as specified at the outset, wherein said bias current is less than 90% of said threshold current, and wherein the laser diode driver further comprises a first converter configured to calculate the amplitudes and a second converter configured to form the current pulses, each two consecutive current pulses being separated by a pause.

The disclosed subject matter breaks with the paradigm of biasing the laser diode to the edge of the lasing regime. Instead, the bias current is considerably lower than the threshold current, i.e. reduced compared to conventional light sources. The first converter calculates the amplitudes of the current pulses such that the resulting current pulses and the emitted laser pulses yield the target brightness of each pixel. To this end, the calculated amplitudes exceed the amplitudes of conventional light sources by the difference of the threshold current and the bias current in order to compensate for the lower bias current. The second converter forms the current pulses with pauses between consecutive ones such that, in each pause, the driving current is significantly below the threshold current which intermits lasing and reduces or breaks the coherence of consecutive laser pulses. Due to the incoherence of consecutive laser pulses the undesired interference effects are suppressed (at least to a non-perceivable level), which improves the quality of the projected image.

The first converter may further account for one or more ambient and/or interior conditions affecting the brightness perceived by a user, e.g. ambient light conditions, temperature induced changes of the laser diode characteristic, an amplification level of an automatic power control (APC) circuit for the laser diode, etc., when calculating the amplitudes, e.g., at the fast rate of pixel processing by the laser diode driver. Hence, the high quality of the image can be sustained even when conditions change quickly.

In a favourable embodiment, the bias current is in a range of 10% to 80%, e.g. of 20% to 70%, for instance of 30% to 60%, of said threshold current. This allows, on the one hand, for efficiently breaking the coherence and, on the other hand, for a fast transformation of each current pulse to the respective laser pulse, i.e. for a fast laser diode response. In addition, a lower bias current also reduces energy consumption of the light source.

The first converter may calculate the amplitudes in many different ways to compensate for the reduced bias current, e.g., according to one of the following beneficial embodiments.

In a first beneficial embodiment, the first converter is configured to calculate each amplitude by scaling the respective brightness value by a scaling factor and adding a bias value. Thereby, the range from the lowest to the highest brightness value and, thus, the range from the lowest to the highest amplitude is scaled to use a desired range of the driving current for laser pulse emission, e.g., the full range between the threshold driving current and a maximum driving current to project the image at a maximal brightness or a smaller range to project the image at a lower brightness, for instance to dim the projection for low ambient brightnesses. In the frequent case of quantised brightness values and amplitudes, the scaling factor is advantageously larger than one. In this case, the scaling factor may be used to convert brightness values of a lower bit depth to amplitudes of a higher bit depth in order to preserve brightness resolution, reduce the influence of round-off errors and, thus, reproduce the target brightnesses particularly precisely by the laser pulses.

In a second beneficial embodiment, the first converter is configured to calculate each amplitude by means of a given non-linear function. Such a non-linear function, e.g. a piecewise linear or a (piecewise) polynomial, logarithmic, exponential, or rational function, etc., can take into account non-linearities of the laser diode characteristic and/or the non-linear perception of brightness by the human eye, e.g. in terms of gamma- and/or gamut-correction. Hence, using the non-linear function allows for projecting the image at a particularly high quality.

In a third beneficial embodiment, the first converter is configured to store a look-up table holding, for each brightness value, the corresponding amplitude, and to calculate each amplitude by retrieval from the look-up table. In this way, the second converter can calculate the amplitudes in a particularly fast and simple manner even for complex dependencies of the amplitudes on the brightness value. Thus, the first converter may be embodied by simple hardware and/or may process many pixels per time interval to project images at a high frame rate and/or resolution. Moreover, dependencies that are inaccurately or infeasibly modelled by functions may be predetermined, e.g., by measurement and stored in the look-up table.

In a second aspect, the disclosed subject matter provides a light source system comprising two or more of the abovementioned light sources, wherein the light sources differ from one another in the wavelengths of the laser pulses they are configured to emit, in order to project a multicoloured image.

In an optional embodiment of the light source system, each of the light sources has a respective laser diode driver which is configured to receive, for each pixel of the image, brightness values, each of which for a different colour, and wherein the first converter of each laser diode driver is configured to calculate the respective amplitude on the basis of the brightness values received for that pixel. In this way, the first converters which, hence, can convert the colour space used for the brightness values, e.g. an RGB colour space, of the pixels to the colour space provided by the different wavelengths of the light sources, e.g. an R′G′B′ colour space having different red, green and blue wavelengths. Thus, the respective other colour channels are admixed when calculating the amplitudes to adapt the same to the available wavelengths. Thereby, also wavelength drifts of the laser diodes which are, e.g., induced by temperature, component ageing, etc. and most often differ for different wavelengths and laser diodes, can be taken into account and compensated when calculating the amplitudes.

In a third aspect, the disclosed subject matter provides a projector for projecting an image, comprising the abovementioned light source or light source system, a mirror assembly with one or more mirrors configured to oscillate and deflect the laser pulses emitted by said one or more light sources, and a waveguide configured to guide the deflected laser pulses towards an image area for projecting said image. Thereby, the laser pulses emitted by the light source/s with a reduced or broken coherence as described above can be guided by the waveguide without undesired interference effects, e.g., Newton rings, to project a high quality image.

To project a multicoloured image, the projector advantageously comprises at least two light sources for emitting laser pulses of different wavelengths, e.g. three light sources with a red, a green and a blue laser diode, respectively.

### BRIEF DESCRIPTION OF THE DRAWINGS

The disclosed subject matter shall now be explained in more detail below on the basis of exemplary embodiments thereof with reference to the accompanying drawings, in which show:

FIG. 1 a projector comprising a light source according to the disclosed subject matter, in the process of projecting an image, in a schematic diagram;

FIG. 2 an exemplary characteristic of a laser diode of the light source of FIG. 1, in a diagram of output power over driving current;

FIGS. 3 and 4 a first and a second exemplary embodiment, respectively, of a first converter of a light source driver of the light source of FIG. 1, in the process of calculating amplitudes from brightness values, in a schematic diagram; and

FIG. 5 a further embodiment of the projector of FIG. 1 comprising three light sources according to the disclosed subject matter, in the process of projecting a multicoloured image, in a schematic diagram.

### DETAILED DESCRIPTION

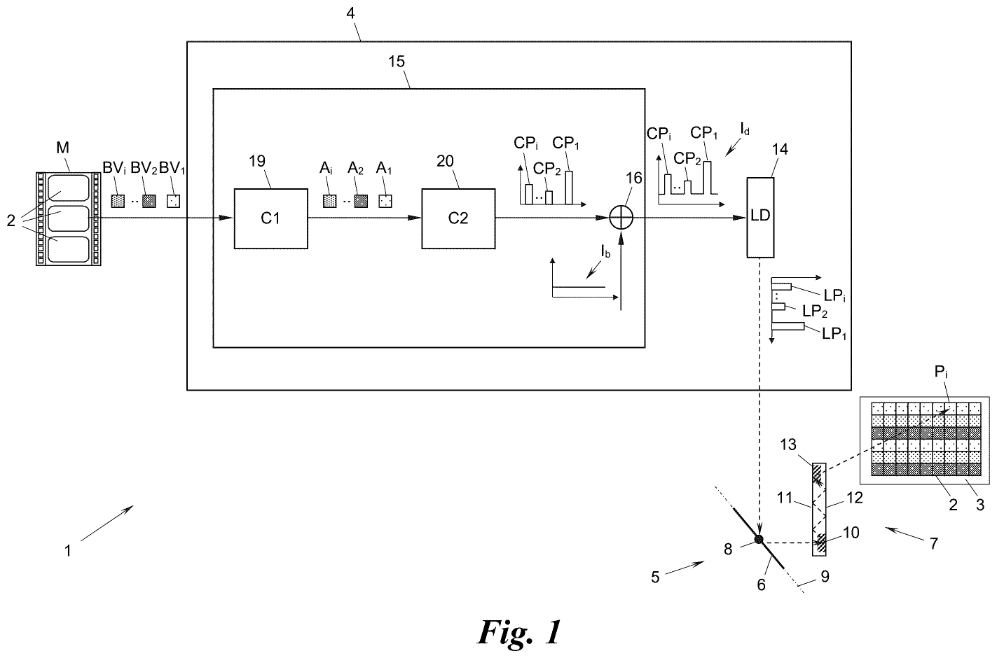

FIG. 1 shows a projector 1 projecting an image 2 comprised of pixels Pᵢ onto an image area 3. The image 2 may be part of a movie M, be a single image, e.g., a photo to be displayed for a longer period of time, be part of a larger image, etc. and may have any desired shape. The image 2 may, e.g., have any pixel resolution according to a conventional image or video standard such as full HD (1920×1080 pixels), UHD (3840×2160 pixels), 4K (4096×2160 pixels) etc., but may also be comprised of a small number of pixels, e.g., of only two, three or four pixels Pᵢ. The image area 3 may be any kind of image area such as a board, projection screen, poster, the retina of an eye, an augmented reality (AR) combiner waveguide, another combiner optics like a holographic combiner or freeform combiner, or the like. Accordingly, the projector 1 may be part of a video beamer, AR or VR (virtual reality) glasses, a helmet, a head-up display, etc.

The projector 1 comprises a light source 4 emitting laser pulses LPᵢ, each for a corresponding pixel Pᵢ of the image 2, a mirror assembly 5 with one or more mirrors 6 which oscillate and deflect the laser pulses LPᵢ, each laser pulse LPᵢ into a direction corresponding to the position of the pixel Pᵢ within the image 2, and a waveguide 7 guiding the deflected laser pulses LPᵢ towards the image area 3 for projecting the image 2 thereon. The mirror assembly 5 may have, e.g., one micro-electro-mechanical-system (MEMS) mirror 6 oscillating about two axes 8, 9 or two MEMS mirrors each oscillating about a respective axis (not shown), to deflect and scan the laser pulses LPᵢ in two directions according to a scanning pattern such as a Lissajous pattern, a raster pattern, a spiral pattern, etc. as known in the art. The waveguide 7 may be any waveguide known in the art and have, e.g., an in-coupling section 10 for coupling the laser pulses LP; in, two parallel sides 11, 12 for guiding the laser pulses LP; and an out-coupling section 13 for coupling the laser pulses LPᵢ out towards the image area 3.

With reference to FIGS. 1 to 4, the light source 4 of the projector 1 shall be described in detail. As can be seen in FIG. 1, the light source 4 comprises a laser diode 14 and a laser diode driver 15 driving the laser diode 14. The laser diode 14 may be any laser diode known in the art, e.g. a Vertical Cavity Surface Emitting Laser (VCSEL), a Fabry-Pérot laser diode, a Distributed Feedback (DFB) laser diode, a Quantum Well laser diode, a Quantum Cascade laser diode, an External Cavity Diode Laser (ECDL), a superluminescent LED (SLED), etc. and the laser diode driver 15 may be any electric circuit capable to carry out the functionalities described herein.

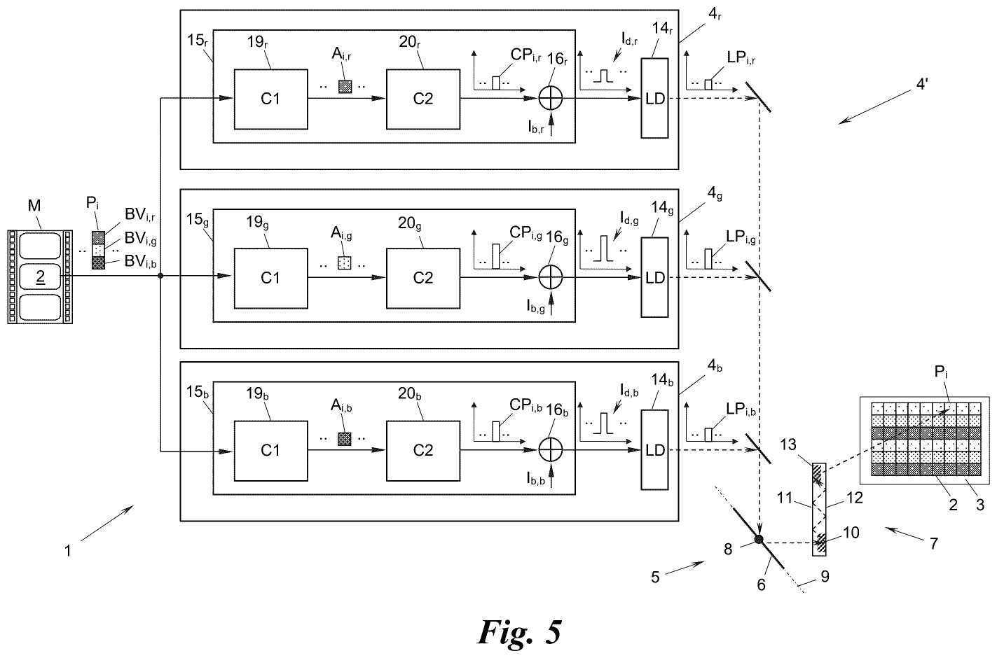

The laser diode driver 15 receives, for each pixel Pᵢ of the image 2, a respective brightness value BVᵢ indicating a target brightness Bᵢ of that pixel Pᵢ. The target brightness Bᵢ is in most cases a desired photometric brightness specifying a perception by a user of the projector 1 and in some cases a desired radiometric brightness specifying an emission of photons by the laser diode 14, e.g. an output power or the like. When projecting a monocoloured, black and white or greyscale image 2, each pixel Pᵢ may hold only one brightness value BVᵢ for the single light source 4 shown in FIG. 1; when projecting a multicoloured image 2, each pixel Pᵢ may hold several brightness values, one for each colour, e.g., a red brightness value BV_{i,r}, a green brightness value BV_{i,g} and a blue brightness value BV_{i,b} for respective red, green and blue light sources 4ᵣ, 4_{g}, 4_{b} as described further below with reference to FIG. 5.

The brightness values BVᵢ may indicate the respective target brightnesses Bᵢ in many ways, e.g., as a percentage or fraction of a maximum target brightness, as an (integer) multiple of a target brightness increment, etc. The brightness values BVᵢ are typically (albeit not necessarily) provided digitally. Depending on the bit depth used, the brightness values BVᵢ for one colour and light source 4 may range from zero to a maximum value, e.g. from 0 to 255 for so called “True Colour” colour depth, from 0 to 511 for so called “Deep Colour” colour depth, etc.

The laser diode driver 15 forms a respective current pulse CPᵢ for each received brightness value BVᵢ, superimposes the current pulses CPᵢ and a constant bias current I_{b} (here: by an adder 16) to obtain a driving current I_{d}, and drives the laser diode 14 with the driving current I_{d}.

The laser diode 14, in turn, is configured to lase whenever the driving current I_{d} exceeds a threshold current Iₜₕ and thus transforms each current pulse CPᵢ, when exceeding the threshold current Iₜₕ, into a respective laser pulse LPᵢ having the target brightness Bᵢ of the respective pixel Pᵢ. The bias current I_{b} is constant throughout the projection of one or more images and may optionally be adjusted from time to time, by hand or by a (slower) feedback control loop, to compensate, e.g., for long-term temperature drifts or ageing of the laser diode 14.

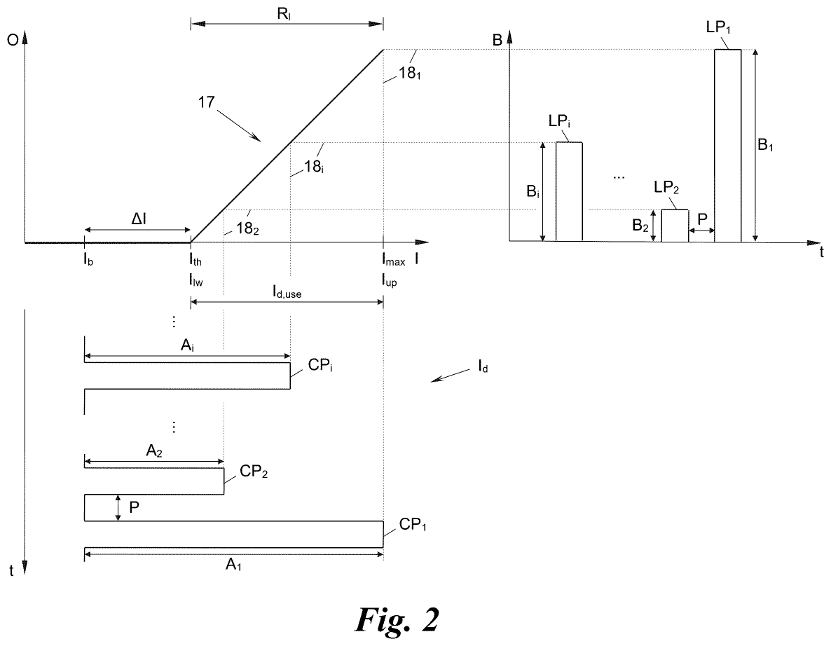

Details of the forming of the current pulse CPᵢ are described with reference to FIG. 2 which illustrates an exemplary characteristic 17 of the laser diode 14 in a diagram of output power O over current I, an exemplary simplified driving current I_{d} over time t below the diagram on the common abscissa of current I, and resulting exemplary laser pulses LPᵢ over time t to the right of the diagram with an ordinate B indicating a photometric or radiometric brightness that is (linearly or non-linearly) related to the output power O.

As shown in FIG. 2, the laser diode driver 15 forms each current pulse CPᵢ with an amplitude Aᵢ that, in a way described below, corresponds to the respective brightness value BVᵢ and yields the target brightness Bᵢ of the respective laser pulse LPᵢ. For instance, the first, second, . . . , generally i-th, current pulse CP₁, CP₂, . . . , CPᵢ, is formed with a respective amplitude A₁, A₂, . . . , Aᵢ, which yields, after superposition with the constant bias current I_{b}, according to the characteristic 17 following the dotted lines 18₁, 18₂, . . . , 18ᵢ, the respective target brightness B₁, B₂, . . . , Bᵢ for the first, second, . . . , i-th laser pulse LP₁, LP₂, . . . , LPᵢ. The amplitudes Aᵢ may be specified in many ways, e.g., as a percentage or fraction of a maximum amplitude, as an (integer) multiple of an amplitude increment, etc.

Other than shown in FIG. 2, laser diode drivers of the state of the art use a bias current that is equal to the threshold current Iₜₕ. In this case, the laser diode is biased to the edge of the lasing regime R₁ of the laser diode characteristic 17, i.e. to the onset of stimulated photon emission, which results in coherent laser pulses.

In contrast thereto, the laser diode driver 15 according to FIG. 2 (i) employs a bias current I_{b} that is less than 90% of the threshold current Iₜₕ, for instance in a range of 10% to 80%, of 20% to 70%, or 30% to 60%, of the threshold current Iₜₕ, (ii) calculates, from the brightness values BVᵢ, the amplitudes Aᵢ which compensate for the lower bias current I_{b}, and (iii) adds pauses P between the current pulses CPᵢ, CPᵢ₊₁. Thereby, the laser diode driver 15 reduces or breaks the coherence of consecutive laser pulses LPᵢ, LPᵢ₊₁ and excludes residual lasing during said pauses P.

To this end, the laser diode driver 15 of FIG. 1 comprises a first converter 19 and a second converter 20. The first converter 19 receives the brightness values BVᵢ and calculates, for each brightness value BVᵢ, the respective amplitude Aᵢ of the respective current pulse CPᵢ which yields—after superposition with the bias current I_{b} by the adder 16 and the transformation by the laser diode 14—the respective laser pulse LPᵢ with the target brightness Bᵢ. When calculating the amplitudes Aᵢ, the first converter 19 takes account for a difference ΔI between the threshold current Iₜₕ and the bias current I_{b} such that the amplitudes Aᵢ are larger than amplitudes of conventional laser diode drivers without this difference ΔI. If the difference ΔI would not be accounted for, the laser pulses LPᵢ would yield too low brightnesses (some not being emitted at all) and the image 2 would be too dark. The first converter 19 may be any converter which can calculate amplitudes Aᵢ from brightness values BVᵢ, e.g., an IC, ASIC, FPGA, CPU, etc. or a part thereof.

The second converter 20, in turn, forms each current pulse CPᵢ with the respective amplitude Aᵢ. When forming the current pulses CPᵢ, the second converter 19 separates each two consecutive pulses CPᵢ, CPᵢ₊₁ by a pause P. Thus, as shown in FIG. 2, each two consecutive current pulses CPᵢ, CPᵢ₊₁ of the driving current I_{d} (lower panel) and the respective two consecutive laser pulses LPᵢ, LPᵢ₊₁ (right panel) are separated by a pause P. Consequently, the driving current I_{d} returns to the bias current I_{b} in said pause P, i.e., falls considerably below the threshold current Iₜₕ, which intermits lasing and breaks the coherence of consecutive laser pulses LPᵢ, LPᵢ₊₁. The second converter 20 may be any converter which can form current pulses CPᵢ from amplitudes Aᵢ, e.g., a digital-to-analog converter (DAC), a digital potentiometer, etc.

The first converter 19 may calculate the amplitudes Aᵢ in many ways, e.g., according to one of the following exemplary embodiments.

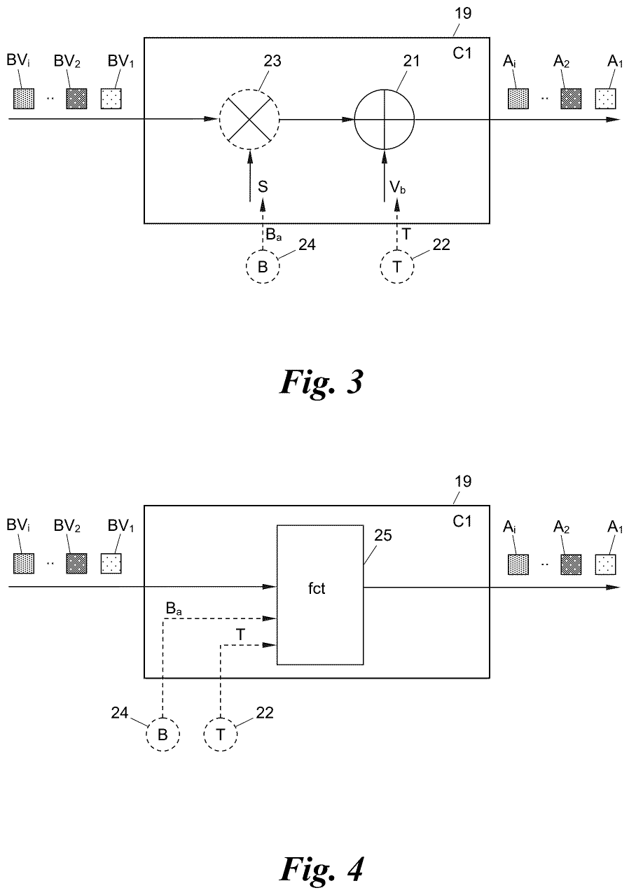

In a first exemplary embodiment shown in FIG. 3, the first converter 19 comprises an adder 21 which adds a bias value V_{b} to each brightness value BVᵢ to calculate the respective amplitude Aᵢ. The bias value V_{b} accounts for the difference ΔI between the threshold current Iₜₕ and the bias current I_{b} and shifts the current pulses CPᵢ of the driving current I_{d} into the lasing regime R₁. The bias value V_{b} may either be predetermined, e.g. by measurement or computation, or determined by the first converter 19 itself, e.g. on-the-fly taking into account a temperature T sensed by a temperature sensor 22 and a given temperature dependence of the threshold current Iₜₕ and thus the difference ΔI, and/or taking into account an amplification level of an automatic power control (APC) circuit for the laser diode 14 (not shown).

FIG. 3 also shows an optional variant of this embodiment, wherein the first converter 19 further comprises a scaler 23 that scales, i.e. multiplies, each brightness value BVᵢ with a scaling factor S before adding the bias value V_{b}. Thereby, the scaler 23 scales the range of the brightness value BVᵢ from its lowest to its highest value and thus a range of the amplitude Aᵢ from its lowest to its highest value. FIG. 2 shows the use range I_{d,use} which is used for emission between a lower driving current I_{lw} and an upper driving current Iᵤₚ. By said scaling and adding, this use range I_{d,use} can be set such that the laser pulses LPᵢ are emitted within a desired corresponding brightness range.

The scaling factor S may be predetermined, e.g. by measurement or computation, optionally such that the use range I_{d,use} is between the threshold driving current Iₜₕ and a maximum driving current Iₘₐₓ of the laser diode 14, i.e. I_{lw}=Iₜₕ and Iᵤₚ=Iₘₐₓ, to project the image 2 at a maximal brightness variation. Alternatively, the scaling factor S may be determined by the first converter 19 itself, e.g. on-the-fly taking into account said amplification level of the APC circuit and/or an ambient brightness Bₐ sensed by a brightness sensor 24 such that, for instance, the upper driving current Iᵤₚ is lower for a lower ambient brightness Bₐ and higher for a higher ambient brightness Bₐ to project the image 2 at an adapted brightness.

The scaling factor S may optionally be larger than one, e.g., when the brightness values BVᵢ are quantised at a lower bit depth and the amplitudes Aᵢ are quantised at a higher bit depth. For instance, when the brightness values BVᵢ are quantised at a bit depth of m bits and the amplitudes Aᵢ are quantised at bit depth of n bits, n being greater than m, the bias value V_{b} and the scaling factor S may be calculated as

$${V}_{b} = \frac{{I}_{th} - {I}_{b}}{{I}_{up} - {I}_{b}} \cdot ( {2}^{n} - 1 ) and S = \frac{( {2}^{n} - 1 ) - {V}_{b}}{{2}^{m} - 1} .$$

In a second exemplary embodiment shown in FIG. 4, the first converter 19 calculates each amplitude Aᵢ by means of a given non-linear function 25. The non-linear function 25, for example, models the light source 4 downstream of the first converter 19 and optionally human perception. Accordingly, the non-linear function 25 may take into account the characteristic of the laser diode 14, e.g., the exemplary piecewise linear characteristic 17 shown in FIG. 2 or a non-linear characteristic (not shown), and/or the non-linear perception of radiometric brightness by the human eye, e.g. in terms of a gamma- and/or gamut-correction. To this end, the non-linear function 25 may be a piecewise linear or a (piecewise) non-linear function, e.g. a polynomial, logarithmic, exponential or rational function, etc., or a mixture thereof.

Optionally, the non-linear function 25 may depend on temperature T (which may be provided by the temperature sensor 22) and/or on ambient brightness Bₐ (which may be provided by the brightness sensor 24), to take into account the temperature dependence of the laser diode characteristic and/or ambient brightness as described above.

In a third exemplary embodiment (not shown), the first converter 19 stores a look-up table which holds, for each brightness value BVᵢ, the respective amplitude Aᵢ and calculates each amplitude Aᵢ by retrieval from the look-up table. The look-up table is typically predetermined by means of measurements or by computation, in particular by simulation, and may take into account the characteristic of the laser diode 14, and/or non-linear perception by a user. Optionally, the look-up table may hold amplitudes Aᵢ for different amplification levels of the APC circuit (which may be provided by the APC circuit), for different temperatures (which may be provided by the temperature sensor 22) and/or for different ambient brightnesses (which may be provided by the brightness sensor 24) to take into account the temperature dependence of the laser diode characteristic and/or ambient brightness as described above.

FIG. 5 shows a further embodiment of the projector 1. In this embodiment, the projector 1 projects a multicoloured image 2 comprised of RGB pixels Pᵢ by means of a red light source 4, emitting red laser pulses LP_{i,r} each having a red target brightness B_{i,r} indicated by a red brightness value BV_{i,r} of a respective pixel Pᵢ, a green light source 4g emitting green laser pulses LP_{i,g} each having a green target brightness Big indicated by a green brightness value BV_{i,g} of the respective pixel Pᵢ, and a blue light source 4b emitting blue laser pulses LP_{i,b} each having a blue target brightness Bib indicated by a blue brightness value BV_{i,b} of the respective pixel Pᵢ. The red, green and blue light sources 4ᵣ, 4_{g}, 4_{b} form a light source system 4′. The laser pulses LP_{i,r}, LP_{i,g}, LP_{i,b} are created as detailed above for the light source 4, wherein same components are denoted by the same reference signs with an index r, g, b for the respective colour. The laser pulses LP_{i,r}, LP_{i,g} and LP_{i,b}, which may optionally be merged, e.g. as shown in FIG. 5, are deflected by the mirror assembly 5 and guided by the waveguide 7 as detailed above.

In an optional embodiment of the light source system 4′, the laser diode drivers 15ᵣ, 15_{g}, 15_{b} also convert the RGB colour space used for pixel encoding to the colour space provided by the wavelengths emitted by the laser diodes 14ᵣ, 14_{g}, 14_{b} by mixing several colour channels. As before, each first converter 19ᵣ, 19_{g}, 19_{b} calculates the respective amplitudes A_{i,r}, A_{i,g}, A_{i,b} for its laser diode, i.e. for the laser diode 14ᵣ, 14_{g}, 14_{b} driven by the laser diode driver 15ᵣ, 15_{g}, 15_{b}. However, in this embodiment, each laser diode driver 15ᵣ, 15_{g}, 15_{b} receives more than one brightness value BVᵢ for each pixel Pᵢ, e.g. the respective red, green and blue brightness values BV_{i,r}, BV_{i,g}, BV_{i,b}, and calculates the respective amplitude A_{i,r}, A_{i,g}, A_{i,b} on the basis of the brightness values received for that pixel Pᵢ, e.g., on the basis of the respective red, green and blue brightness values BV_{i,r}, BV_{i,g}, BV_{i,b}. Thereby, also wavelength drifts of the laser diodes can be taken into account when converting the RGB pixel colour space to the colour space provided by the current wavelengths emitted by the laser diodes 14ᵣ, 14_{g}, 14_{b}.

Optionally, the first converters 19ᵣ, 19_{g}, 19_{b} and/or the second converters 20ᵣ, 20_{g}, 20_{b} may be embodied as a single unit, e.g., as a common first converter unit, as a common second converter unit or as a common laser driver.

It is noted that the light source 4 and the light source system 4′ described herein may be employed in many types of projectors, e.g., also in projectors without a mirror assembly and/or without a waveguide.

The disclosed subject matter is not restricted to the specific embodiments described above but encompasses all variants, modifications and combinations thereof that fall within the scope of the appended claims.

What is claimed is:

1. A light source for a projector projecting an image comprised of pixels, the light source comprising a laser diode and a laser diode driver,
wherein the laser diode driver is configured to receive, for each pixel of the image, a respective brightness value indicating a target brightness of that pixel, to form, for each brightness value, a respective current pulse having an amplitude corresponding to that brightness value, thus forming current pulses, to superimpose a constant bias current and the current pulses for obtaining a driving current, and to drive the laser diode with the driving current,
wherein the laser diode is configured to lase when the driving current exceeds a threshold current and to transform each current pulse into a respective laser pulse yielding the target brightness of the respective pixel;
wherein said bias current is less than 90% of said threshold current, and wherein the laser diode driver further comprises a first converter configured to calculate the amplitudes and a second converter configured to form the current pulses, each two consecutive current pulses being separated by a pause.

2. The light source according to claim 1, wherein said bias current is in a range of 10% to 80% of said threshold current.

3. The light source according to claim 1, wherein said bias current is in a range of 20% to 70% of said threshold current.

4. The light source according to claim 1, wherein said bias current is in a range of 30% to 60% of said threshold current.

5. The light source according to claim 1, wherein the first converter is configured to calculate each amplitude by scaling the respective brightness value by a scaling factor and adding a bias value.

6. The light source according to claim 5, wherein the scaling factor is larger than one.

7. The light source according to claim 1, wherein the first converter is configured to calculate each amplitude by means of a given non-linear function.

8. The light source according to claim 1, wherein the first converter is configured to store a look-up table holding, for each brightness value, the corresponding amplitude, and to calculate each amplitude by retrieval from the look-up table.

9. A light source system comprising two or more light sources according to claim 1, wherein the two or more light sources differ from one another in the wavelengths of the laser pulses they are configured to emit.

10. The light source system according to claim 9, wherein each of the two or more light sources has a respective laser diode driver which is configured to receive, for each pixel of the image, brightness values, each of which for a different colour, and wherein the first converter of each laser diode driver is configured to calculate the respective amplitude on the basis of the brightness values received for that pixel.

11. A projector for projecting an image, comprising the light source according to claim 1, a mirror assembly with one or more mirrors configured to oscillate and deflect the laser pulses emitted by said light source, and a waveguide configured to guide the deflected laser pulses towards an image area for projecting said image.
